(19) United States
(12) Patent Application Publication
(10) Pub. No.: US 2026/0299913 A1
(43) Pub. Date: Oct. 1, 2026

(54) DEPENDENCY FULFILLMENT DURING DYNAMIC IMPORTS FOR EXTENDABLE FRAMEWORKS

(71) Applicant: Dell Products L.P., Round Rock, TX (US)

(72) Inventors: Ana Smith, Chicago, IL (US); Smriti Bajaj, Seattle, WA (US); Ítalo Gomes Santana, Rio de Janeiro (BR); Miguel Paredes Quiñones, Campinas (BR); Brendan Burns Healy, Haddonfield, NJ (US)

(21) Appl. No.: 19/094,026

(22) Filed: Mar. 28, 2025

(51) Int. Cl. G06F 8/61; G06F 8/71

(52) U.S. Cl. CPC G06F 8/61; G06F 8/71

(57) ABSTRACT

One example method for improving installation and/or operation of a multi-component application includes combining, by a configurator, respective metadata of functional components of an application into a metadata graph, using, by the configurator, the metadata graph to generate a use case configuration file, passing the use case configuration file to an orchestrator, installing, by the orchestrator, dependencies of the functional components, and by the orchestrator, instantiating the functional components of the application and executing the functional components according to the use case configuration file.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to multi-component applications. More particularly, at least some embodiments relate to systems, hardware, software, computer-readable media, architectures, and methods, for dependency fulfillment during dynamic imports for extendable frameworks.

### BACKGROUND

Developing a highly customizable application with rapidly changing sets of components presents many challenges. One challenge concerns the footprint of the application. Adding support for new components increases the number of dependencies between/among components, and modifying the application with new components can become unmanageable when components are introduced at a rapid rate, and retired almost as fast. Conventionally, the dependencies are fulfilled during application installation. This works well for smaller applications with few components, and when most components are utilized. However, this is impractical for applications with numerous components, especially when usage of the components is sparse.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example architecture, according to one embodiment.

FIG. 2 discloses aspects of an example functional component of an application, according to one embodiment.

FIG. 3 discloses aspects of an example method, according to one embodiment.

FIG. 4 discloses aspects of a configuration for one example use case, according to one embodiment.

FIG. 5 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to multi-component applications. More particularly, at least some embodiments relate to systems, hardware, software, computer-readable media, architectures, and methods, for dependency fulfillment during dynamic imports for extendable frameworks.

One or more embodiments embrace a method, schema, and architecture, configured and operable to perform various operations in connection with the use and modification of a multi-component application. Such operations may include, for example, dynamic fulfillment of dependencies for each component of an application, where the dynamic fulfillment may be implemented in tandem with dynamic imports of application components at the object level, rather than at a library level. Embodiments may operate in connection with both the addition, and removal, of one or more components of an application.

A method according to one example embodiment may be performed in connection with functional components of an application, where the functional components each comprise a respective metadata file and a file containing the implementation, that is, the executable implementation code, of the function(s) to be performed by the functional components. This file may also be referred to herein as an ‘implementation file.’ This example method, which may be cooperatively performed by a configurator and an orchestrator, may comprise various operations including, but not limited to: combining, by the configurator, respective metadata of functional components into a metadata graph; using, by the configurator, the metadata graph to generate a use case configuration file; passing the use case configuration file to an orchestrator; installing, by the orchestrator, dependencies of the functional components; and, by the orchestrator, instantiating the functional components and executing the functional components according to the use case configuration file. In an embodiment, the metadata graph may be updated automatically to reflect the addition, or removal, of one or more functional components, and an updated use case configuration file generated automatically as well based on changes to the metadata graph.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that dependencies for each functional component of an application are fulfilled dynamically in tandem with dynamic imports at the object level, not at the library level. An embodiment may reduce the footprint of an application by minimizing the number of installed dependencies. An embodiment may reduce, relative to conventional approaches, the probability that dependency conflicts will arise. An embodiment may make an application relatively easier to maintain by virtue, at least, of reductions in dependencies between/among functional components of the application. Various other advantages of one or more example embodiments will be apparent from this disclosure.

### A. Overview of Aspects of One or More Example Embodiments

One or more example embodiments comprise a dynamic approach to dependency fulfillment which works in tandem with dynamic imports. In an embodiment, the dependencies of a functional component of an application are installed only if there is a request for that component to be instantiated. In this way, the number of installed dependencies and, thus, the complexity and footprint of the application, can be held to a minimum.

As such, embodiments may be well positioned to deal with current challenges, one of which is that highly configurable and extendable platforms supporting frequently changing sets of components have significant functional component dependencies. This causes the installation process to take a very long time, and the size of the environment to be unnecessarily large. Moreover, the use of numerous dependencies cause dependency conflicts, making, for example, the realization of the entire solving pipeline of QUBO-based problems an arduous task. It is noted that ‘QUBO’ refers to Quadratic Unconstrained Binary Optimization, which is a mathematical modelling for combinatorial optimization problems.

### B. Detailed Discussion of Aspects of One or More Embodiments

One or more embodiments comprise a framework that makes highly customizable applications light and flexible. Such embodiments may simplify the addition of new functional components and their dependencies, while also removing obsolete or unneeded functional components, to keep applications as lightweight as possible, while preserving their intended functionalities.

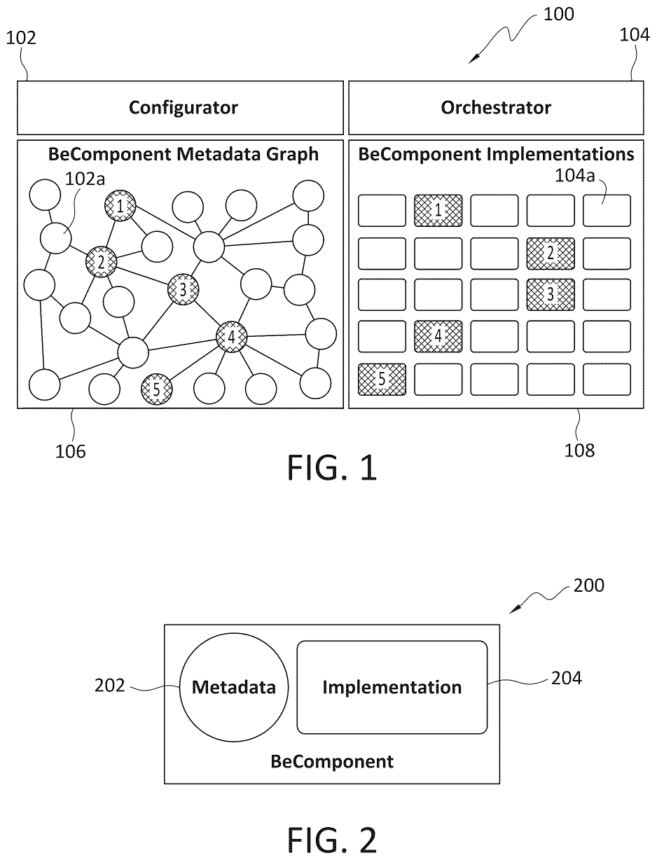

With attention now to FIG. 1, and example architecture 100 is disclosed. As shown, the example architecture 100 may comprise a configurator 102 and an orchestrator 104. The configurator 102 handles the respective metadata 102a of one or more functional components, while the orchestrator 104 handles the respective implementations 104a of one or more functional components. The architecture 100 may thus be said to separate, for one or more functional components, the metadata of the functional component from the implementation of the functional component. As shown in the example of FIG. 2, a functional component 200 may thus comprise two elements, namely, metadata 202, and a functional component implementation 204.

Thus, as collectively indicated by the examples of FIGS. 1 and 2, one or more embodiments may comprise various pillars. These pillars may comprise, in particular, functional components 104a/200, a configurator 102, and an orchestrator 104. Details concerning these example pillars, and their operation, are provided below.

### B.1 Functional Components

In an embodiment, each of the functional components 200/104a comprises two artifacts. As shown in the example of FIG. 2, these artifacts may comprise a metadata file 202, and an implementation file 204. These artifacts may, in an embodiment, be inherited from a base abstract class, or classes. The base abstract class may be particularly useful in the example use case discussed below.

The metadata file 202 of a functional component may comprise various fields and information, that is, metadata. Following are some examples of metadata that may be included in a metadata file 202 according to one embodiment.
1. Name: The name of the functional component. The orchestrator 104 uses this to instantiate and execute the functional component.
2. Location: The location of the file containing the implementation, that is, the implementation file. The orchestrator 104 may import the implementation file dynamically.
3. Parents: The names of the functional component(s) that can be executed immediately before this functional component. The configurator 102 updates a framework metadata graph 106 by adding this element to a parents'list of children.
4. Children: The names of the functional component(s) that can be executed immediately after this component. The configurator 102 uses this list to display the available options for configuration generation.
5. Dependencies: The module containing the implementation for this functional component, and the other dependencies used by this functional component. The orchestrator 104 uses this module to install the functional component and its dependencies immediately before the instantiation of the functional component, that is, when a flag is set to ‘true.’
6. Configuration: The name, data type, and description of each attribute that can customize this functional component. The configurator 102 uses this field to collect configuration values during the configuration generation.

With reference again to the example of FIG. 1, each of the functional components is represented by a numbered node in the metadata graph 106, and functional component implementation map 108, shown in FIG. 1 and performs a task in a particular use case.

The metadata graph 106 may be application specific and include all functional components and dependencies of an application. In an embodiment, a new or modified metadata graph 106 may be generated, possibly automatically, for a functional component that is to be instantiated. Such an update, which may reflect the addition, or removal, of a functional component of an application, may be used as a basis to identify dependencies that should be implemented, and dependencies that may be disabled or eliminated. A metadata graph 106 may comprise all dependencies between/among all expected, or possible, functional components of an application, but only those dependencies needed for a particular use case may be implemented at any one time.

By way of illustration and not limitation, and with reference to the example of FIG. 1, to heuristically solve a Travelling Salesman Problem (TSP) with simulated annealing, functional components may comprise a parent component TSP problem parser (node 1) with its child being a QUBO compiler (node 2) and grandchild being a solver-such as OpenJiJ (https://www.openjij.org/) for example-as another functional component (node 3). The sequence of these functional components may be important to avoid dependency conflicts, and for an efficient implementation of the use case.

### B.2 Configurator

In an embodiment, the configurator 102 comprises a module that assists with the functional components 104a/200 integration and use case configuration. The configurator 102 may cooperate with the orchestrator 104 in various embodiments.

### B.3 Orchestrator

In an embodiment, the orchestrator module 104 helps install the functional components 104a/200 and execute the use case. The orchestrator module 104 may cooperate with the configurator 102 in various embodiments.

### C. Example Workflow According to One or More Embodiments

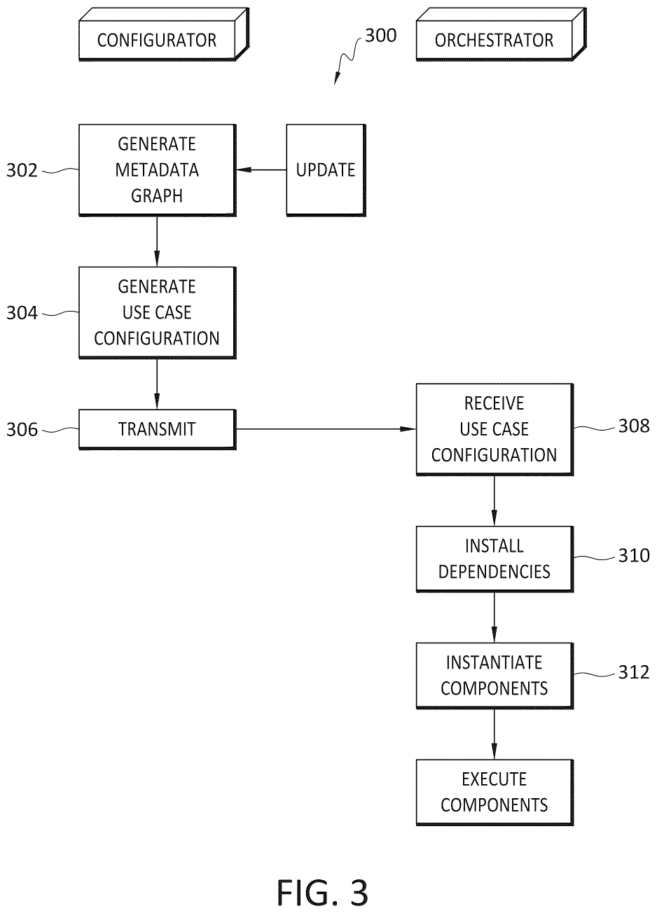

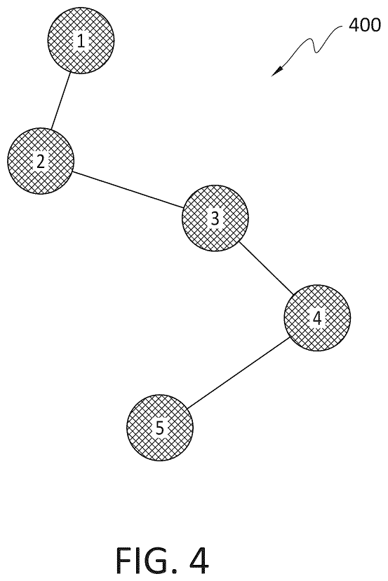

With attention now to the examples of FIG. 3 (workflow) and FIG. 4 (use case configuration), details are provided concerning further aspects of one or more embodiments. For integration, the configurator 102 generates 302 a new/modified metadata graph by combining the metadata of each supported functional component, as shown in the example metadata graph 106 of FIG. 1. In an embodiment, the integration may be considered as completed if the metadata file dependencies field contains the implementation from the base abstract class.

For execution, the configurator 102 uses the metadata graph 106 to interactively generate 304 a use case configuration 400 as shown in FIG. 4, which is then passed 306 to, and received by 308, the orchestrator 104. An embodiment may also accommodate semi-automated use case configuration generation.

In an embodiment, the configuration field of the metadata file 202 of a functional component 200 may be generated iteratively to meet a goal set by the user. To illustrate, and with reference to the example metadata graph 106 of FIG. 1, consider again the example in which a Travelling Salesman Problem (TSP) must be solved. If node 2 compiles the QUBO, node 3 solves it, and node 4 validates the answer, node 4 may iteratively request node 2 to recompile the QUBO with new Lagrange values until the solution is acceptable as measured against a quality threshold. This would happen in the subsequent runs semi-automatically with minimum user intervention after at least one round of the workflow has happened. The final path, that is, the use case configuration, would be made of these nodes visited at least once.

With continued reference to the example method 300 disclosed in FIG. 3, the orchestrator 104 may install 310 the dependencies of the functional components identified in the use case configuration 400, instantiate 312 the functional components, and execute 314 the functional components according to the use case configuration file. In an embodiment, the installation 310 of dependencies may be optional as it can be included in the first run but excluded in subsequent runs.

### D. Further Discussion

As disclosed herein, one or more embodiments may comprise various useful features, aspects, and advantages, although no embodiment is required to possess any of such features, aspects, or advantages. The follow examples are illustrative, but not exhaustive.

In an embodiment, the dependencies for each functional component may be fulfilled dynamically in tandem with dynamic imports at the object level, not the library level. By way of contrast with one or more embodiments, dependency fulfillment in conventional approaches remains at the library or module level, resulting in unused dependencies that may, among other things, slow the operation of the application.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method for improving installation and/or operation of a multi-component application, comprising: combining, by a configurator, respective metadata of functional components of an application into a metadata graph; using, by the configurator, the metadata graph to generate a use case configuration file; passing the use case configuration file to an orchestrator; installing, by the orchestrator, dependencies of the functional components; and by the orchestrator, instantiating the functional components of the application and executing the functional components according to the use case configuration file.

Embodiment 2. The method as recited in claim 1, wherein the dependencies are shown in the metadata graph.

Embodiment 3. The method as recited in claim 1, wherein only the dependencies of the instantiated functional components are installed.

Embodiment 4. The method as recited in claim 1, wherein dependencies not connected to any of the functional components are not installed.

Embodiment 5. The method as recited in claim 1, wherein dependencies for a newly added functional component are automatically installed.

Embodiment 6. The method as recited in claim 1, wherein dependencies for a retired functional component are automatically deleted, and removed from the metadata graph.

Embodiment 7. The method as recited in claim 1, wherein a number of the dependencies is a minimum needed to meet requirements of the use case.

Embodiment 8. The method as recited in claim 1, wherein the metadata graph depicts all functional components and dependencies of the application.

Embodiment 9. The method as recited in claim 1, wherein each of the functional components comprises a respective metadata file, and a respective implementation file.

Embodiment 10. The method as recited in claim 1, wherein a respective metadata file of each of the functional components comprises a name of a parent that can be executed immediately before the functional component, and a name of a child that can be executed immediately after the functional component.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

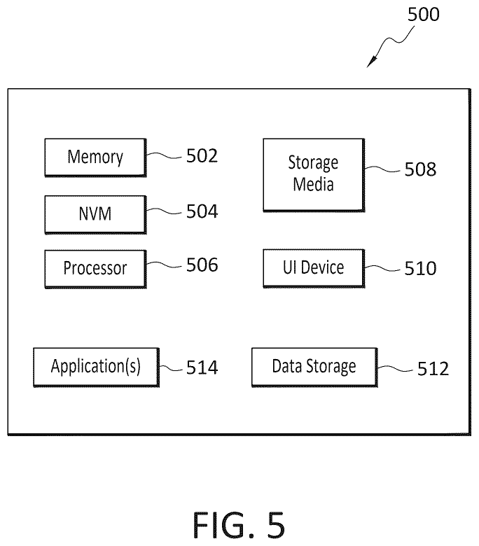

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 5008, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for improving installation and/or operation of a multi-component application, comprising:
combining, by a configurator, respective metadata of functional components of an application into a metadata graph;
using, by the configurator, the metadata graph to generate a use case configuration file;
passing the use case configuration file to an orchestrator;
installing, by the orchestrator, dependencies of the functional components; and
by the orchestrator, instantiating the functional components of the application and executing the functional components according to the use case configuration file.

2. The method as recited in claim 1, wherein the dependencies are shown in the metadata graph.

3. The method as recited in claim 1, wherein only the dependencies of the instantiated functional components are installed.

4. The method as recited in claim 1, wherein dependencies not connected to any of the functional components are not installed.

5. The method as recited in claim 1, wherein dependencies for a newly added functional component are automatically installed.

6. The method as recited in claim 1, wherein dependencies for a retired functional component are automatically deleted, and removed from the metadata graph.

7. The method as recited in claim 1, wherein a number of the dependencies is a minimum needed to meet requirements of the use case.

8. The method as recited in claim 1, wherein the metadata graph depicts all functional components and dependencies of the application.

9. The method as recited in claim 1, wherein each of the functional components comprises a respective metadata file, and a respective implementation file.

10. The method as recited in claim 1, wherein a respective metadata file of each of the functional components comprises a name of a parent that can be executed immediately before the functional component, and a name of a child that can be executed immediately after the functional component.

11. A non-transitory storage medium having stored therein instructions that are executable by one or more hardware processors to perform operations comprising:
combining, by a configurator, respective metadata of functional components of an application into a metadata graph;
using, by the configurator, the metadata graph to generate a use case configuration file;
passing the use case configuration file to an orchestrator;
installing, by the orchestrator, dependencies of the functional components; and
by the orchestrator, instantiating the functional components of the application and executing the functional components according to the use case configuration file.

12. The non-transitory storage medium as recited in claim 11, wherein the dependencies are shown in the metadata graph.

13. The non-transitory storage medium as recited in claim 11, wherein only the dependencies of the instantiated functional components are installed.

14. The non-transitory storage medium as recited in claim 11, wherein dependencies not connected to any of the functional components are not installed.

15. The non-transitory storage medium as recited in claim 11, wherein dependencies for a newly added functional component are automatically installed.

16. The non-transitory storage medium as recited in claim 11, wherein dependencies for a retired functional component are automatically deleted, and removed from the metadata graph.

17. The non-transitory storage medium as recited in claim 11, wherein a number of the dependencies is a minimum needed to meet requirements of the use case.

18. The non-transitory storage medium as recited in claim 11, wherein the metadata graph depicts all functional components and dependencies of the application.

19. The non-transitory storage medium as recited in claim 11, wherein each of the functional components comprises a respective metadata file, and a respective implementation file.

20. The non-transitory storage medium as recited in claim 11, wherein a respective metadata file of each of the functional components comprises a name of a parent that can be executed immediately before the functional component, and a name of a child that can be executed immediately after the functional component.
